(19) United States
(12) Patent Application Publication
(10) Pub. No.: US 2011/0086146 A1
(43) Pub. Date: Apr. 14, 2011

(54) ANTIMICROBIAL COMPOSITIONS FOR MEAT PROCESSING

(75) Inventor: Carl J. Knueven, Bowling Green, OH (US)

(73) Assignee: JONES-HAMILTON CO., Walbridge, OH (US)

(21) Appl. No.: 12/719,146

(22) Filed: Mar. 8, 2010

Related U.S. Application Data
(60) Provisional application No. 61/250,067, filed on Oct. 9, 2009.

(51) Int. Cl. A23B 4/20

(52) U.S. Cl. 426/332; 426/652

(57) ABSTRACT

A method and composition for reducing microbes during a meat processing operation are provided. The composition includes an acid blend that is a blend of (a) an organic acid selected from the group consisting of lactic acid, acetic acid, and mixtures thereof, and (b) a second material selected from the group consisting of alkali metal salts of an inorganic acids, mineral acids, and mixtures thereof.

### CROSS-REFERENCE TO RELATED APPLICATION

This application claims the benefit of U.S. Provisional Application No. 61/250,067, filed Oct. 9, 2009, the disclosure of which is incorporated herein by reference.

### BACKGROUND OF THE INVENTION

This invention relates in general to antimicrobial compositions, and in particular to antimicrobial compositions for meat processing.

During meat processing, the meat may encounter microbes which can make it unsuitable for consumption. The microbes may come from the meat itself, the contact surfaces during processing, and/or the surrounding environment. The microbes can range from pathogenic microbes to spoilage organisms that can affect the taste, color, and/or smell of the meat.

Meat processors use a variety of methods during processing to reduce microbes on meats. These methods include cleaning and sanitizing the processing plant environment, applying an antimicrobial composition to the meat, irradiating the meat, applying heat, and others.

Applying an antimicrobial composition to the meat is a preferred way of reducing microbes. However, it is difficult to formulate a composition that is effective at reducing microbes using ingredients that are acceptable for direct contact with meat according to government regulations. Further, it is difficult to formulate a composition that can be applied directly to meat without adversely affecting its color, taste or smell.

A variety of antimicrobial compositions are known for use during the processing of meats. However, there is still a need for improved antimicrobial compositions for meat processing.

### SUMMARY OF THE INVENTION

A method of reducing microbes comprises applying to meat during a meat processing operation an antimicrobial composition. The composition includes an acid blend that is a blend of (a) an organic acid selected from the group consisting of lactic acid, acetic acid, and mixtures thereof, and (b) a second material selected from the group consisting of alkali metal salts of an inorganic acids, mineral acids, and mixtures thereof.

In a particular method, the antimicrobial composition includes an organic acid and an alkali metal salt of an inorganic acid, and the amount of the alkali metal salt is sufficient to keep substantially all the organic acid in the undissociated form of the acid.

An antimicrobial composition for applying to meat during a meat processing operation comprising an acid blend in an aqueous medium. The acid blend includes a blend of (a) an organic acid selected from the group consisting of lactic acid, acetic acid, and mixtures thereof, and (b) a second material selected from the group consisting of alkali metal salts of an inorganic acids, mineral acids, and mixtures thereof.

### DETAILED DESCRIPTION OF THE PREFERRED EMBODIMENT

The present invention relates to antimicrobial compositions for meat processing. The antimicrobial compositions include a particular acid blend that is effective for reducing microbes, and that comprises food grade acids which are safe for human consumption. The acid blend is a blend of (a) an organic acid selected from the group consisting of lactic acid, acetic acid, and mixtures thereof, and (b) a second material selected from the group consisting of alkali metal salts of an inorganic acids, mineral acids, and mixtures thereof.

The organic acids for use in the compositions are carboxylic acids. Lactic acid (2-hydroxypropanoic acid) has the chemical formula of CH₃CHOHCOOH, and acetic acid (ethanoic acid) has the chemical formula of CH₃COOH.

The alkali metal salts of inorganic acids for use in the compositions convert to acids when hydrated with sufficient water. Some examples of alkali metals include sodium, potassium and lithium, and some examples of inorganic acids include sulfate, phosphate and nitrate. In certain embodiments, the metal salts are alkali metal bisulfates which include, for example, sodium bisulfate (i.e., sodium acid sulfate or sodium hydrogen sulfate), potassium bisulfate (i.e., potassium acid sulfate or potassium hydrogen sulfate), or mixtures thereof.

Food grade sodium acid sulfate is manufactured and sold as pHase™ by Jones-Hamilton Co. in Walbridge Ohio. It has been certified as GRAS (Generally Recognized As Safe), and it meets Food Chemicals Codex, 5th Edition Specifications. The sodium acid sulfate is in dry granular crystalline form in particle sizes that can be readily and uniformly dispersed and solubilized in aqueous media. In certain embodiments, the particles having a generally spherical shape with an average diameter from about 0.03 mm to about 1 mm, typically about 0.75 mm. Also, in certain embodiments, the product includes sodium bisulfate in an amount from about 91.5% to about 97.5% by weight (typically about 93%), and sodium sulfate in an amount from about 2.5% to about 8.5% by weight (typically about 7%).

The Jones-Hamilton food grade sodium acid sulfate is low in impurities. In certain embodiments, the product contains less than about 0.003% heavy metals as Pb, less than about 0.05% water-insoluble substances, and less than about 0.003% selenium by weight. Also, in certain embodiments, the product has a moisture content of less than about 0.8% (measured by loss on drying).

The mineral acid for use in the antimicrobial compositions includes inorganic acids such as food grade sulfuric acid, hydrochloric acid, phosphoric acid, and mixtures thereof. In certain embodiments, the mineral acid is sulfuric acid.

The antimicrobial compositions can include the acid blend alone or in combination with other ingredients. The antimicrobial composition may have a range of physical forms. For example, the composition may be in the form of a liquid, a thickened liquid, a gel, or a foam. When in the form of a liquid, the antimicrobial composition includes the acid blend dissolved or suspended in a liquid carrier. In certain embodiments, the carrier is an aqueous medium that includes water and sometimes other materials. In other embodiments, the carrier can include an organic solvent alone or in a mixture with water.

The carrier can be included in any suitable amount in the antimicrobial composition. Generally, the carrier makes up a large portion of the composition and may be the balance of the composition apart from the acid blend, adjuvants, and the like. In certain embodiments, the antimicrobial composition includes about 80 wt % to about 99.5 wt % carrier.

The acid blend can be included in the antimicrobial composition in any suitable amount. The types and amounts of the materials in the acid blend are sufficient to cause a significant bacterial reduction. In certain embodiments, in which the acid blend is included in an aqueous medium, the acid blend is sufficient to lower the pH of the medium to within a range of from about 0.5 to about 2.5, and more particularly from about 0.7 to about 1.5. Also, in certain embodiments in which the antimicrobial composition includes an organic acid and an alkali metal salt of an inorganic acid in an aqueous medium or other liquid carrier, the composition may include from about 0.2% to about 5% organic acid and from about 0.2% to about 5% alkali metal salt, more particularly from about 0.5% to about 2.5% organic acid and about 0.5% to about 2.5% alkali metal salt, and more particularly from about 0.5% to about 1% organic acid and about 0.5% to about 1% alkali metal salt.

Further, in certain embodiments in which the antimicrobial composition includes an organic acid and an alkali metal salt of an inorganic acid, the amount of the alkali metal salt is sufficient to keep substantially all the organic acid in the undissociated form of the acid. For example, when the composition includes lactic acid and sodium acid sulfate, the amount of the sodium acid sulfate is sufficient to keep the lactic acid in the lactic acid form rather than the lactate form. While not intending to be limited by theory, it is believed that the undissociated form of the acid is more efficacious for microbial reduction than the dissociated form.

In certain embodiments, for example when the antimicrobial composition is an aqueous medium used for scalding, washing, rinsing or chilling carcasses as described below, during use the composition will also include organic materials from the carcasses, such as fat, oil, proteins, lipids, carbohydrates and small solid particles, which are dissolved and/or suspended in the aqueous medium. The load of the organic materials can vary depending on the particular carcass processing operation. In certain embodiments, the antimicrobial composition during use contains from about 0.1 wt % to about 5 wt % organic materials.

The antimicrobial compositions can also include any number of adjuvants that are useful in the compositions, and that do not substantially inhibit the antimicrobial efficacy of the acid blend. Such adjuvants can include, for example, food grade surfactants, defoaming agents, thickeners and/or aesthetic enhancing agents (e.g., flavoring aids, colorants and/or odorants).

In certain embodiments, the antimicrobial compositions are formed using materials that are all GRAS or food additives. Also, the compositions may be formulated as a ready-to-use composition or a concentrate.

The antimicrobial composition can be prepared by any suitable method(s). The composition may be prepared by combining the above-described components using processes and procedures well known to those of ordinary skill in the art. For example, the acid blend and any other materials can be dissolved or suspended in an aqueous medium with suitable mixing.

The antimicrobial compositions are used for reducing microbes during meat processing. The term “microbe” is synonymous with “microorganism,” and refers to any noncellular or unicellular (including colonial) organism, including all prokaryotes. Microbes include bacteria (including cyanobacteria), lichens, fungi, protozoa, virinos, viroids, viruses, phages, and some algae. In certain embodiments, the microbes are bacteria associated with meat, such as Escherichia coli, Salmonella, Campylobacter, Listeria, Pseudomonas, Acinetobacter, Moraxella, Alcaligenes, Flavobacterium, Erwinia, yeast, mold, or the like.

The term “meat” refers to a portion of an animal that has been cut or harvested for consumption. It includes all forms of animal flesh, including the carcass, muscle, fat, organs, skin, bones and other components that form the animal. The term “carcass” refers to a sacrificed animal prepared or being prepared for harvesting or recovering meat, meat products, meat byproducts, or the like. The carcass can be skinned, headless, or the like. Animal flesh includes the flesh of mammals, birds, fishes, reptiles, amphibians, crustaceans, and other edible species. In certain embodiments, the meat is a carcass of beef, pork or poultry.

The antimicrobial compositions are useful for applying to meat during meat processing operations. The compositions may be used during any stage(s) of the process in which they are effective for reducing microbes on the meat.

For example, during the processing of meats such as beef and pork, the carcasses are typically subjected to a carcass wash procedure to remove contamination. This can be done by any suitable method, for example, by spraying or immersing the carcasses using a wash water. Many commercial meat processors use wash cabinets for the carcass wash procedure. The wash cabinet is an enclosure with nozzles for spraying the wash water onto the carcass. The wash cabinet allows adjustment of the spray pattern, the pressure of the water and the volume of water applied. The time the carcass is in the cabinet can also be adjusted. The antimicrobial compositions can be used in the carcass wash water.

The beef or pork carcasses are also typically subjected to a chilling operation near the end of the process to prevent the growth of microbes and to reduce meat deterioration while the meat awaits distribution. This can be done by any suitable method, for example, by spraying or immersing the carcasses using cold water. Many commercial meat processors use a spray chill system for the chilling operation. The spray chill system includes nozzles for spraying the chill water onto the carcass, and allows for adjustment in the spray pattern, the pressure of the water, the volume of water applied, the temperature of the water, and the duration of the spray. The antimicrobial compositions can be used in the carcass chill water.

After chilling, the primal (better quality) cuts of meat are removed from the carcass. What is left on the skeleton after removal of the primal cuts is known as the “trim” or “trimmings,” because these materials are often trimmed off the skeleton and used to make ground beef or ground pork. The trimmings can be treated with the antimicrobial composition either before or after their removal from the skeleton, for example, by spraying or immersing the trimmings using an aqueous medium including the antimicrobial composition.

As another example, during the processing of poultry the antimicrobial compositions can be used in the water applied during any of the stages of the processing operation. Poultry processing typically begins with sacrificing the bird followed by neck cutting and bleeding. A first washing step, known as scalding, typically follows bleeding and loosens attachment of feathers of the bird. Submersion scalding typically includes immersing the carcass into a scalding hot bath of water. After scalding, the carcass is typically defeathered before the next washing process. This post-scalding washing process is generally a rinsing process known as a dress rinsing. The rinsing typically includes spraying the carcass with water, or alternatively flood rinsing or submersing the carcass.

Typically, the carcass is dismembered and eviscerated and then subjected to another washing process. The washing process is known as inside-outside bird washing, and typically includes rinsing the interior and exterior surfaces of the carcass with streams or floods of water. After washing, the interior and exterior of the bird can be subjected to further decontamination by spray rinsing. After spray rinsing, the bird can be made ready for packaging or further processing by chilling. Submersion chilling includes submersing the carcass in cold water or slush, and both washes and cools the bird to retain quality of the meat.

The antimicrobial composition can remain on the meat after the meat processing operation, or the composition can be removed from the meat.

In addition to being applied to meat during meat processing operations, the antimicrobial compositions can also be useful for application to meat processing surfaces. The phrase “meat processing surface” refers to a surface of a tool, a machine, equipment, a structure, a building, or the like that is employed as part of a meat processing operation. Examples of meat processing surfaces include surfaces of meat processing or preparation equipment, of meat processing wares, and of floors, walls, or fixtures of structures in which meat processing occurs.

The antimicrobial compositions can have any suitable degree of effectiveness for reducing bacteria and other microbes. In certain embodiments, the antimicrobial composition is effective to reduce at least one of E. coli bacteria or Salmonella bacteria by at least 1 log-unit after 5 minutes exposure time as measured by AOAC Method 960.09. In some particular embodiments, the composition reduces bacteria by at least 2 log-units after 5 minutes exposure time, and/or it reduces bacteria by at least 1 log-unit after 1 minute exposure time. For example, the bacteria which are reduced may be E. coli O157:H7 ATCC #43894 and/or Salmonella serotype enteritidis (ATCC 13076) or others.

Also, in certain embodiments, the acid blend has a synergistic effect in reducing microbes compared with lactic acid alone. For example, the antimicrobial composition including the acid blend, when compared with a control antimicrobial composition including an amount of lactic acid equal to the total amount of the acid blend, causes at least twice the bacterial reduction after 1 minute and 5 minutes exposure time. In other words, when the same amount of materials are used in an acid blend compared with lactic acid alone, the antimicrobial composition is at least twice as effective in reducing microbes.

In certain other embodiments, the antimicrobial composition including the acid blend, when compared with a control antimicrobial composition including an amount of lactic acid which is 33 wt % greater than the total amount of the acid blend, causes at least twice the bacterial reduction after 1 minute and 5 minutes exposure time. In other words, even compared with a composition containing a greater amount of acid, the acid blend is still at least twice as effective in reducing microbes.

### EXAMPLE 1

Objective: To evaluate the efficacy of blends of sodium acid sulfate (SAS) and lactic acid (LA), compared with lactic acid alone, in reducing bacteria on growth medium (TSA).

Methods:

The research used sodium acid sulfate provided by Jones-Hamilton Co. and lactic acid from a commercial supplier. Test acid solutions of lactic acid, and of lactic acid plus SAS, were prepared in sterile deionized (DI) water and in sterile deionized water with organic material (0.3% horse blood serum, HBS). Assay control solutions of sterile Butterfield's phosphate buffer (BPB) were also prepared with and without HBS. About 200 ml of each solution was prepared, and the pH of the solution was measured prior to initiating the inoculated portion of the study. The test acid solutions and assay control solutions are listed below:
1) 2% lactic acid in DI water, pH 2.34
2) 2% lactic acid in DI water w\0.3% HBS, pH 2.39
3) 1% lactic acid plus 0.5% SAS in DI water, pH 2.05
4) 1% lactic acid plus 0.5% SAS in DI water w\0.3% HBS, pH 2.11
5) 1% lactic acid plus 1.0% SAS in DI water, pH 2.01
6) 1% lactic acid plus 1.0% SAS in DI water w\0.3% HBS, pH 1.99
7) Assay control 1: BPB, pH 6.82
8) Assay control 2: BPB w\0.3% HBS, pH 6.75

The following strains of Salmonella were used in this study: Salmonella serotype enteritidis (ATCC 13076), Salmonella serotype typhimurium (ATCC 14028), Salmonella serotype montevideo (ATCC 8387), Salmonella serotype newport (ATCC 6962), and Salmonella serotype choleraesuis (ATCC 13312). The following strains of E. coli O157:H7 were used in this study: ATCC #43894, ATCC #43895, and ATCC #700599. These bacterial strains are derived from clinical or animal sources and are commonly used in process validation, intervention validation, and preservative efficacy studies with meat and poultry products.

Each bacterial strain was grown separately via at least two serial transfers at 35° C. for 24 hr in tryptic soy broth (TSB). Bacterial cells for each culture were harvested by centrifugation at 10,000×g for 10 min and washed twice with BPB, pH 7.2. Each strain was then resuspended, equally combined, and concentrated in BPB to obtain a cell suspension of about 5×10⁹ CFU/ml. All inoculum suspensions were enumerated on appropriate media.

A modification of AOAC Method 960.09 (Germicidal and Detergent Sanitizing Action of Disinfectants) was used to test the antimicrobial efficacy of the test solutions:
1) For each of the acid test solutions and assay control solutions, eight sterile screw cap test tubes containing 9.9 ml of the solution were prepared. The tubes with solutions were equilibrated to room temperature (21-24° C.) before initiating the efficacy tests.
2) For each inoculum, four test tubes of each solution prepared as above were inoculated by adding 0.1 ml of the designated inoculum suspension (at 1×10⁹ CFU/ml). This yielded an inoculum level of about 10⁷ CFU/ml in each tube. The tubes were vortexed immediately after inoculation and prior to each sample aliquot collection.
3) For each inoculum/solution combination, two tubes were sampled 1 min after inoculation and two more tubes 5 min after inoculation.
4) Tubes were sampled by aseptically transferring a 1.0 ml aliquot to a dilution blank/tube containing 9.0 ml of D-E neutralizing broth to yield an initial dilution of 1:10 (10⁻¹).

Sample aliquots from the initial (10⁻¹) D-E neutralizing tubes were serially diluted in BPB and enumerated via surface plating on pre-poured plates of tryptic soy agar. The plates were then incubated for 24 h at 35° C.

Bacterial counts were expressed as colony forming units (CFU) per ml of sample solution and converted to log₁₀ transforms. Microbial counts were transformed to log₁₀ CFU/ml. The log₁₀ and percentage reductions (versus the respective control sample) were calculated for each inoculum/solution/time.

Results:

As background, bacterial log-unit (log₁₀) reduction is synonymous with lethality, inactivation, and/or bactericidal activity. Bacterial reductions of less than 1 log-unit are considered to be insignificant. Log-unit reductions are equivalent to percentage reductions as follows: 1 log-unit=90% reduction, 2 log-units=99% reduction, 3 log-units=99.9% reduction, 4 log-units=99.99% reduction, and 5 log-units=99.999% reduction.

The results for Salmonella inactivation presented as log-unit reductions after 1 and 5 min exposure times in the acid solutions are shown below in Table 1. Salmonella reductions after a 5 min exposure time were greater than corresponding reductions after a 1 min exposure time for all acid solutions. The acid solutions with a combination of SAS and lactic acid (LA) were more effective in reducing the Salmonella than corresponding “2% LA only” solutions at each exposure time. Salmonella reductions were generally not affected by the presence of organic matter (0.3% HBS) in the acid solutions. The Salmonella counts were significantly reduced (i.e., ≧1 log-unit) in the clean and dirty “SAS plus LA” solutions after 1 min whereas reductions in the clean or dirty “2% LA only” solutions were not significant after 1 min. The Salmonella counts were significantly reduced (i.e., ≧1 log-unit) in all acid solutions after a 5 min exposure time. Salmonella reductions after 5 min in the clean “2% LA only” solution, the clean “1% LA+0.5% SAS” solution, and the clean “1% LA+1% SAS” solution were 1.22, 2.67, and 4.50 log₁₀ units, respectively (equivalent to 93.974%, 99.786%, and 99.997%, respectively).

The results for E. coli O157:H7 inactivation presented as log-unit reductions after 1 and 5 min exposure times in the acid solutions are shown in Table 2. The acid solutions were not as effective against E. coli O157:H7 as they were against Salmonella. None of the acid solutions was effective in reducing the E. coli O157:H7 after a 1 min exposure time. Additionally, neither the “2% LA only” nor the “1% LA+0.5% SAS” solutions were (significantly) effective against E. coli O157:H7 after a 5 min exposure. However, the “1% LA+1% SAS” solutions (with or without the presence of organic matter) were effective in reducing E. coli O157:H7 counts (i.e., ≧1 log-unit) after a 5 min exposure. E. coli O157:H7 reductions after 5 min in the clean and dirty “1% LA+1% SAS” solutions were 1.03 and 1.19 log₁₀ units, respectively (equivalent to 90.67% and 93.54%, respectively).

TABLE 1
Antimicrobial Effect of Acid Combinations Against Salmonella

| | | Exposure Time | | | |
|---|---|---|---|---|---|
| | | 1 minute | | 5 minutes | |
| | | | Log₁₀ | | Log₁₀ |
| Solutions | | CFU/ml | CFU/ml | CFU/ml | CFU/ml |
| Control | rep. 1 | 17,000,000 | 7.23 | 21,000,000 | 7.32 |
| (buffered water, BPB) | rep. 2 | 8,900,000 | 6.95 | 22,000,000 | 7.34 |
| | Mean | | 7.09 | | 7.33 |
| 2% LA | rep. 1 | 4,700,000 | 6.67 | 1,400,000 | 6.15 |
| (DI water) | rep. 2 | 4,300,000 | 6.63 | 1,200,000 | 6.08 |
| | Mean | | 6.65 | | 6.11 |
| | Log10 reduction | | 0.44 | | 1.22 |
| 1% LA & 0.5% SAS | rep. 1 | 490,000 | 5.69 | 34,000 | 4.53 |
| (DI water) | rep. 2 | 3,000,000 | 6.48 | 62,000 | 4.79 |
| | Mean | | 6.08 | | 4.66 |
| | Log10 reduction | | 1.01 | | 2.67 |
| 1% LA & 1% SAS | rep. 1 | 220,000 | 5.34 | 470 | 2.67 |
| (DI water) | rep. 2 | 950,000 | 5.98 | 1,000 | 3.00 |
| | Mean | | 5.66 | | 2.84 |
| | Log10 reduction | | 1.43 | | 4.50 |
| Control w/organic | rep. 1 | 11,000,000 | 7.04 | 15,000,000 | 7.18 |
| material | rep. 2 | 23,000,000 | 7.36 | 15,000,000 | 7.18 |
| (0.3% HBS in BPB) | Mean | | 7.20 | | 7.18 |
| 2% LA w/organic | rep. 1 | 4,300,000 | 6.63 | 690,000 | 5.84 |
| material | rep. 2 | 4,900,000 | 6.69 | 820,000 | 5.91 |
| (0.3% HBS in DI water) | Mean | | 6.66 | | 5.88 |
| | Log10 reduction | | 0.54 | | 1.30 |
| 1% LA & 0.5% SAS | rep. 1 | 580,000 | 5.76 | 26,000 | 4.41 |
| w/organic material | rep. 2 | 1,600,000 | 6.20 | 40,000 | 4.60 |
| (0.3% HBS in DI water) | Mean | | 5.98 | | 4.51 |
| | Log10 reduction | | 1.22 | | 2.67 |
| 1% LA & 1% SAS | rep. 1 | 300,000 | 5.48 | 24,000 | 4.38 |
| w/organic material | rep. 2 | 680,000 | 5.83 | 9,600 | 3.98 |
| (0.3% HBS in DI water) | Mean | | 5.65 | | 4.18 |
| | Log10 reduction | | 1.55 | | 2.99 |

Notes:
1) Pathogen counts expressed as CFU per ml of inoculated solution.
2) Log reduction = (log-unit count of respective “control” solution) − (log-unit count of respective antimicrobial solution).

TABLE 2
Antimicrobial Effect of Acid Combinations Against E. Coli

| | | Exposure Time | | | |
|---|---|---|---|---|---|
| | | 1 minute | | 5 minutes | |
| | | | Log₁₀ | | Log₁₀ |
| Solutions | | CFU/ml | CFU/ml | CFU/ml | CFU/ml |
| Control | rep. 1 | 24,000,000 | 7.38 | 16,000,000 | 7.20 |
| (buffered water, BPB) | rep. 2 | 20,000,000 | 7.30 | 16,000,000 | 7.20 |
| | Mean | | 7.34 | | 7.20 |
| 2% LA | rep. 1 | 27,000,000 | 7.43 | 22,000,000 | 7.34 |
| (DI water) | rep. 2 | 23,000,000 | 7.36 | 22,000,000 | 7.34 |
| | Mean | | 7.40 | | 7.34 |
| | Log10 reduction | | −0.06 | | −0.14 |
| 1% LA & 0.5% SAS | rep. 1 | 17,000,000 | 7.23 | 12,000,000 | 7.08 |
| (DI water) | rep. 2 | 25,000,000 | 7.40 | 9,900,000 | 7.00 |
| | Mean | | 7.31 | | 7.04 |
| | Log10 reduction | | 0.03 | | 0.17 |
| 1% LA & 1% SAS | rep. 1 | 11,000,000 | 7.04 | 1,300,000 | 6.11 |
| (DI water) | rep. 2 | 11,000,000 | 7.04 | 1,700,000 | 6.23 |
| | Mean | | 7.04 | | 6.17 |
| | Log10 reduction | | 0.30 | | 1.03 |
| Control w/organic | rep. 1 | 16,000,000 | 7.20 | 23,000,000 | 7.36 |
| material | rep. 2 | 16,000,000 | 7.20 | 39,000,000 | 7.59 |
| (0.3% HBS in BPB) | Mean | | 7.20 | | 7.48 |
| 2% LA w/organic | rep. 1 | 18,000,000 | 7.26 | 20,000,000 | 7.30 |
| material | rep. 2 | 22,000,000 | 7.34 | 21,000,000 | 7.32 |
| (0.3% HBS in DI water) | Mean | | 7.30 | | 7.31 |
| | Log10 reduction | | −0.094 | | 0.16 |
| 1% LA & 0.5% SAS | rep. 1 | 22,000,000 | 7.34 | 4,900,000 | 6.69 |
| w/organic material | rep. 2 | 21,000,000 | 7.32 | 11,000,000 | 7.04 |
| (0.3% HBS in DI water) | Mean | | 7.33 | | 6.87 |
| | Log10 reduction | | −0.13 | | 0.61 |
| 1% LA & 1% SAS | rep. 1 | 14,000,000 | 7.15 | 1,500,000 | 6.18 |
| w/organic material | rep. 2 | 19,000,000 | 7.28 | 2,500,000 | 6.40 |
| (0.3% HBS in DI water) | Mean | | 7.21 | | 6.29 |
| | Log10 reduction | | −0.01 | | 1.19 |

Notes:
1) Pathogen counts expressed as CFU per ml of inoculated solution.
2) Log reduction = (log-unit count of respective “control” solution) − (log-unit count of respective antimicrobial solution).

In summary, bacterial reductions after a 5 min exposure time were greater than corresponding reductions after a 1 min exposure time for all acid solutions. The Salmonella counts were significantly reduced (i.e., ≧1 log-unit) in all acid solutions after a 5 min exposure time with the combination LA/SAS acid solutions being more effective than the corresponding “2% LA only” solutions. None of the acid solutions was effective in reducing the E. coli O157:H7 after a 1 min exposure time. The “1% LA+1% SAS” solution was the most effective acid solution against both pathogens and was the only acid solution effective in reducing E. coli O157:H7 by at least one log unit (after 5 min).

### EXAMPLE 2

Objective: To evaluate the efficacy of blends of sodium acid sulfate (SAS) and lactic acid (LA), compared with lactic acid alone, in reducing bacteria on beef samples.

Procedure: Beef plates will be cut into 15×40 cm sections. The plates will be inoculated with an E. coli surrogate cocktail consisting of ATCC BAA-1427, BAA-1428, BAA-1429, BAA-1430, and BAA-1431. After inoculation, the samples will be stored at 4° C. for 20 minutes to allow bacteria to attach to the meat samples.

Beef plate sections will be run through a custom built spray cabinet (Chad Company, Olathe, Kans.) at set specifications where treatment will be applied. Treatments include 5% total solids (2.5% Lactic Acid/2.5% Sodium Acid Sulfate (SAS)), 3% total solids (1.5% Lactic Acid/1.5% SAS), 2.5% Lactic Acid, 2.5% SAS, 5% Lactic Acid, and water. After treatment is applied, samples will be allowed to drip dry for 20 minutes at 4° C. After samples have been allowed to drip dry, a 100 cm² section will be excised and placed in stomacher bag. Beef plate sections and pork butts will be vacuum packaged and stored at 4° C.

Four 100 cm² sections will be excised from the plates. The first excision will be taken at time zero, twenty minutes after treatment is applied. The second and third excision will be removed at 24 and 48 hours post-treatment. A final excision will be removed at 20 days post-treatment. Excised samples will be placed into a filtered stomacher bag with 225 ml of peptone water. Samples will homogenized for two minutes and a dilution series will be conducted to dilute the sample to a 10⁻⁴ dilution. The diluted samples will be plated on Trypticase Soy Agar and Violet Red Bile Agar with MUG, which selects for coliforms including E. coli, and incubated at 37° C. for 48 hours. Bacterial colonies will be counted and total plate counts will be calculated.

What is claimed is:

1. A method of reducing microbes comprising applying to meat during a meat processing operation an antimicrobial composition which includes an acid blend that is a blend of (a) an organic acid selected from the group consisting of lactic acid, acetic acid, and mixtures thereof, and (b) a second material selected from the group consisting of alkali metal salts of an inorganic acids, mineral acids, and mixtures thereof.

2. The method of claim 1 wherein the acid blend comprises a blend of lactic acid and an alkali metal salt of an inorganic acid.

3. The method of claim 2 wherein the alkali metal salt comprises sodium acid sulfate.

4. The method of claim 2 wherein the antimicrobial composition comprises from about 0.2 wt % to about 5 wt % lactic acid and from about 0.2 wt % to about 5 wt % alkali metal salt.

5. The method of claim 4 wherein the antimicrobial composition comprises from about 0.5 wt % to about 1 wt % lactic acid and from about 0.5 wt % to about 1 wt % sodium acid sulfate.

6. The method of claim 1 wherein the antimicrobial composition comprises the acid blend in an aqueous medium.

7. The method of claim 6 wherein the antimicrobial composition is used for washing or chilling carcasses during the meat processing operation.

8. The method of claim 6 wherein the antimicrobial composition is applied to trimmings during the meat processing operation.

9. The method of claim 1 wherein the antimicrobial composition is effective to reduce E. coli or Salmonella bacteria by at least 1 log-unit after 5 minutes exposure time as measured by AOAC Method 960.09.

10. The method of claim 9 wherein the antimicrobial composition is effective to reduce the bacteria by at least 2 log-units after 5 minutes exposure time.

11. The method of claim 9 wherein the antimicrobial composition causes at least twice the bacterial reduction after 5 minutes exposure time when compared with a control antimicrobial composition including an amount of lactic acid equal to the total amount of the acid blend.

12. The method of claim 11 wherein the antimicrobial composition causes at least twice the bacterial reduction when compared with a control antimicrobial composition including an amount of lactic acid which is 33 wt % greater than the total amount of the acid blend.

13. A method of reducing microbes comprising applying to meat during a meat processing operation an antimicrobial composition which includes an acid blend that is a blend of (a) an organic acid selected from the group consisting of lactic acid, acetic acid, and mixtures thereof, and (b) an alkali metal salt of an inorganic acid, the amount of the alkali metal salt being sufficient to keep substantially all the organic acid in the undissociated form of the acid.

14. The method of claim 13 wherein the organic acid comprises lactic acid and the alkali metal salt comprises sodium acid sulfate.

15. An antimicrobial composition for applying to meat during a meat processing operation comprising an acid blend in an aqueous medium, the acid blend including a blend of (a) an organic acid selected from the group consisting of lactic acid, acetic acid, and mixtures thereof, and (b) a second material selected from the group consisting of alkali metal salts of an inorganic acids, mineral acids, and mixtures thereof.

16. The composition of claim 15 wherein the acid blend comprises a blend of lactic acid and an alkali metal salt of an inorganic acid.

17. The composition of claim 16 wherein the alkali metal salt comprises sodium acid sulfate.

18. The composition of claim 16 wherein the antimicrobial composition comprises from about 0.2 wt % to about 5 wt % lactic acid and from about 0.2 wt % to about 5 wt % alkali metal salt.

19. The composition of claim 16 wherein the antimicrobial composition further comprises from about 0.1 wt % to about 5 wt % organic material from a meat carcass.

20. The composition of claim 16 further comprising from about 0.1 wt % to about 5 wt % organic materials selected from the group consisting of fats, oils, proteins, lipids, carbohydrates, small solid organic materials, and mixtures thereof.
